(19) United States
(12) Patent Application Publication
(10) Pub. No.: US 2008/0307296 A1
(43) Pub. Date: Dec. 11, 2008

(54) SYSTEM AND METHOD FOR PRE-RENDERING OF COMBINED DOCUMENT PAGES

(76) Inventor: Jose Elwin Simon Maglanque, Regents Park (AU)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 11/760,271

(22) Filed: Jun. 8, 2007

(51) Int. Cl. G06F 3/14; G06F 17/00

(52) U.S. Cl. 715/202

(57) ABSTRACT

The subject application is directed to a system and method for pre-rendering of combined document pages. First, electronic document data inclusive of page data representing a plurality of document pages is received. A combine instruction is then received to combine the received page data. Multiple document pages are then combined into each of at least one output page in accordance with the received combine instruction. The combination includes first scaling multiple document pages associated with an output page and positioning each of the multiple document pages within a corresponding output page. The output pages are then communicated to an associated document rendering device so as to generate an output of output pages.

### BACKGROUND OF THE INVENTION

The subject application is directed generally to generating output pages from a combination of input pages. The application is particularly advantageous in generating booklet form output or n-up output while balancing processor power so as to offload demand from a frequently strained document processing controller.

Electronic documents, such as those created by word processing packages, drawing packages, incoming facsimile messages, scanner input, electronic mail input, and the like, are typically encoded as a series of pages. When such documents are output, such as by printing, each page is rendered on a separate sheet. In the case of duplex printing, pages may be rendered on both the front and back of an output sheet.

It is frequently desirable to combine multiple pages encoded in an electronic document into a single output page. N-up printing is defined as an output wherein multiple pages are combined into a single page, being arranged for example as four pages with each occupying a quadrant of an output page. N-up printing is advantageously used for conserving tangible stock, such as in review of drafts. It is also useful as a tool for quickly reviewing more than one page concurrently.

Booklet form printing allows for multiple pages to be combined on an output page in such a fashion that allows for them to be folded and stacked such that a logical sequence of pages is resultant from the combination.

Typical n-up or booklet form printing accomplished combination of output pages by sending an electronic document, at full resolution, to an output device such as a printer. Intelligence associated with a document processor, such as a controller, would be used to render the pages at full resolution, such as 600 DPI, and then combine the full resolution rendering into n-up or booklet form. At this point, resolution would be scaled so that combined pages would be output at the resolution of the output device.

While effective, earlier systems for n-up or booklet rendering required much data manipulation, and required it to be completed at the printer level.

### SUMMARY OF THE INVENTION

In accordance with one embodiment of the subject application, there is provided a system and method for generating output pages from a combination of input pages.

Further, in accordance with one embodiment of the subject application, there is provided a system and method for generating booklet form output or n-up output while balancing processor power so as to offload demand from a frequently strained document processing controller.

Still further, in accordance with one embodiment of the subject application, there is provided a system for pre-rendering of combined document pages. The system comprises means adapted for receiving electronic document data inclusive of page data representative of a plurality of document pages and means adapted for receiving a combine instruction to combine page data. The system also comprises combination means adapted for combining multiple document pages into each of at least one output page in accordance with a received combine instruction wherein the combination means include scaling means adapted for scaling multiple document pages associated with a corresponding output page and positioning means adapted for positioning each of the multiple document pages within a corresponding output page. The system further comprises means adapted for communicating output pages to an associated document rendering device so as to generate an output of output pages therefrom.

In one embodiment of the subject application, the combination means includes a filter means adapted for filtering received electronic document data, and wherein the scaling means and the positioning means are completed via at least one filtering operation completed on the filter means.

In another embodiment of the subject application, the combine instruction includes an instruction for combining page data into n-up output page data.

In a further embodiment of the subject application, the combine instruction includes an instruction for combining page data into booklet form page data.

In yet another embodiment of the subject application, the combine instruction includes an instruction for combining page data into duplex form page data.

In a further embodiment of the subject application, the page data defines content of the document pages at a higher resolution relative to corresponding content defined in output pages.

Still further, in accordance with one embodiment of the subject application, there is provided a method for pre-rendering of combined document pages in accordance with the system as set forth above

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for pre-rendering of combined document pages according to one embodiment of the subject application;

FIG. 2 is a block diagram illustrating controller hardware for use in the system for pre-rendering of combined document pages according to one embodiment of the subject application;

FIG. 3 is a functional diagram illustrating the controller for use in the system for pre-rendering of combined document pages according to one embodiment of the subject application;

FIG. 4 is a flowchart illustrating a method for pre-rendering of combined document pages according to one embodiment of the subject application; and

FIG. 5 is a flowchart illustrating a method for pre-rendering of combined document pages according to one embodiment of the subject application.

FIG. 6 is a flowchart illustrating a method for pre-rendering of combined document pages according to one embodiment of the subject application.

### DETAILED DESCRIPTION OF THE PREFERRED EMBODIMENT

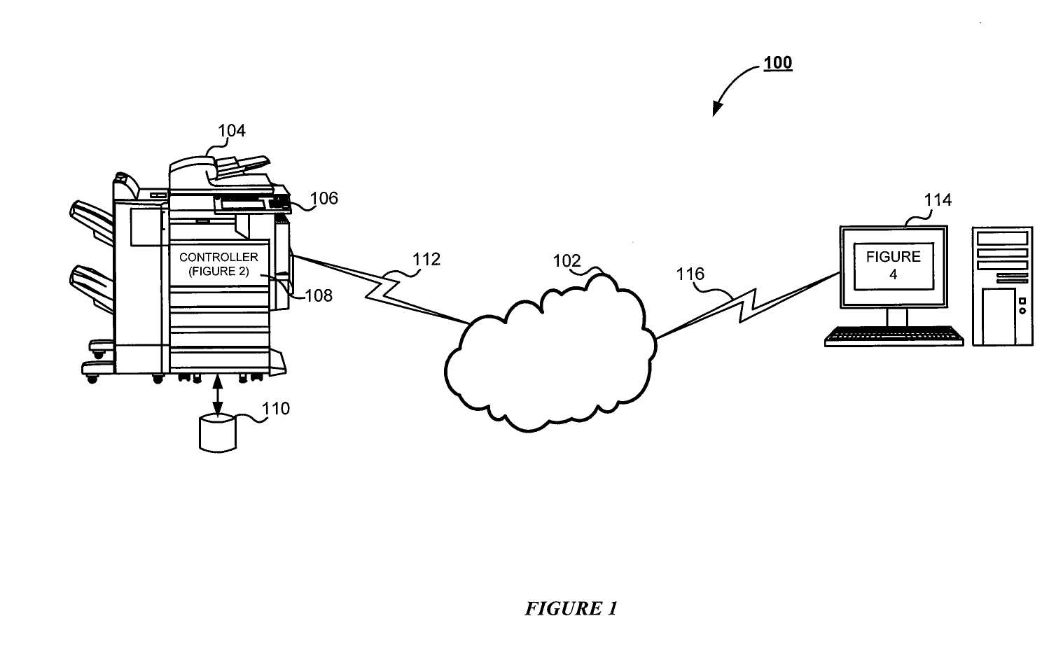

The subject application is directed to a system and method for generating output pages from a combination of input pages. In particular, the subject application is directed to a system and method for generating booklet form output or n-up output while balancing processor power so as to offload demand from a frequently strained document processing controller. It will become apparent to those skilled in the art that the system and method described herein are suitably adapted to a plurality of varying electronic fields employing pre-processing, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for pre-rendering of combined document pages in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or the any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document rendering device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document rendering devices include, for example and without limitation, the Toshiba e-Studio Series Controller. In accordance with one aspect of the subject application, the document rendering device 104 is suitably adapted to provide remote document processing services to external or network devices. Preferably, the document rendering device 104 includes hardware, software, and any suitable combination thereof, configured to interact with an associated user, a networked device, or the like.

According to one embodiment of the subject application, the document rendering device 104 is suitably equipped to receive a plurality of portable storage media, including, without limitation, Firewire drive, USB drive, SD, MMC, XD, Compact Flash, Memory Stick, and the like. In the preferred embodiment of the subject application, the document rendering device 104 further includes an associated user interface 106, such as a touch-screen, LCD display, touch-panel, alpha-numeric keypad, or the like, via which an associated user is able to interact directly with the document rendering device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document rendering device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

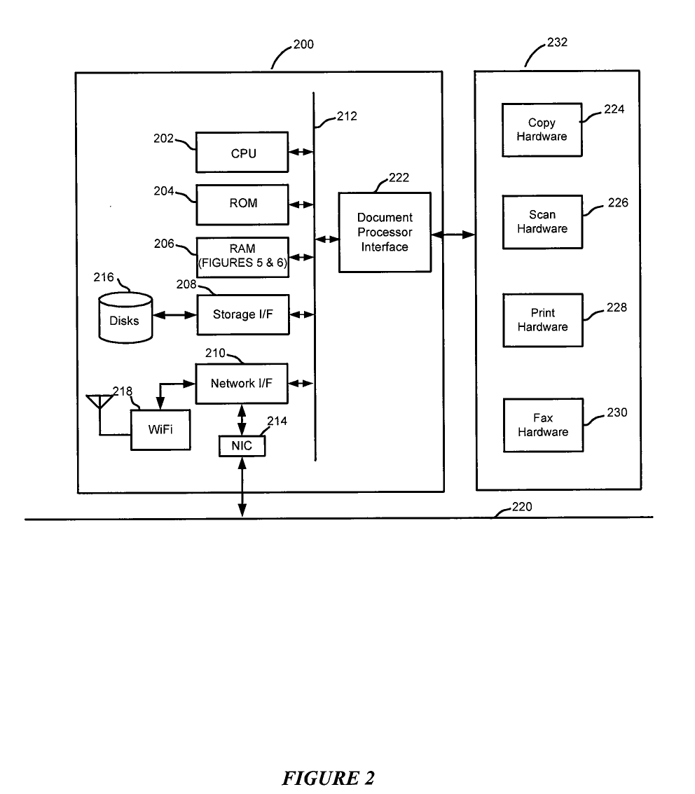

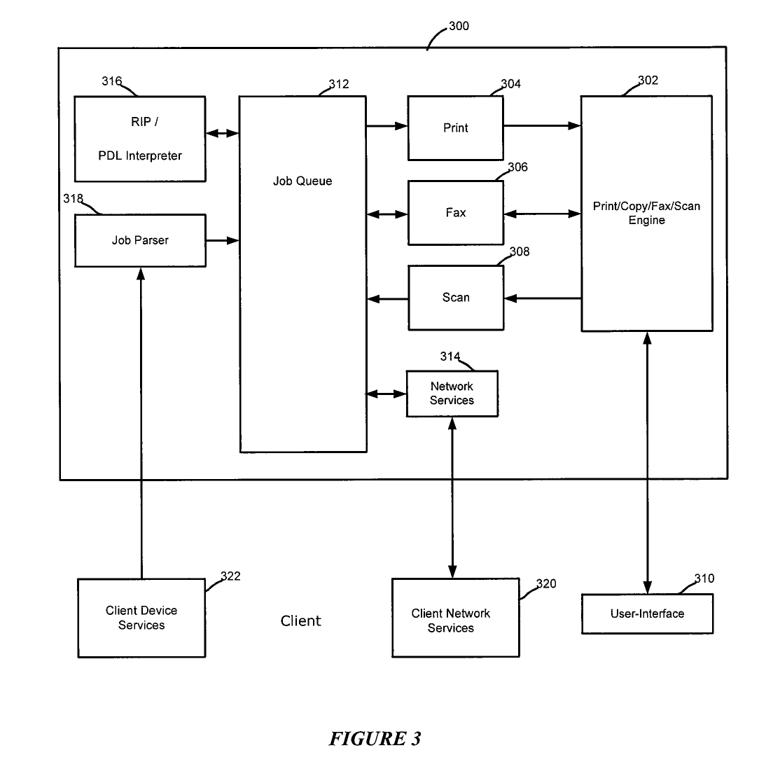

In accordance with one embodiment of the subject application, the document rendering device 104 further incorporates a backend component, designated as the controller 108, suitably adapted to facilitate the operations of the document rendering device 104, as will be understood by those skilled in the art. Preferably, the controller 108 is embodied as hardware, software, or any suitable combination thereof, configured to control the operations of the associated document rendering device 104, facilitate the display of images via the user interface 106, direct the manipulation of electronic image data, and the like. For purposes of explanation, the controller 108 is used to refer to any myriad of components associated with the document rendering device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for pre-rendering of combined document pages of the subject application. The functioning of the controller 108 will better be understood in conjunction with the block diagrams illustrated in FIGS. 2 and 3, explained in greater detail below.

Communicatively coupled to the document rendering device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store a document data, image data, electronic database data, or the like. It will be appreciated by those skilled in the art that while illustrated in FIG. 1 as being a separate component of the system 100, the data storage device 110 is capable of being implemented as internal storage component of the document rendering device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document rendering device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 108 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by bus 212.

Also in data communication with bus the 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document rendering device, such as the document rendering device 104, which includes the controller 200 of FIG. 2, (shown in FIG. 1 as the controller 108) as an intelligent subsystem associated with a document rendering device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document rendering devices that are subset of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably functions to receive print job language files from an external device, such as client device services 322. The client device services 322 suitably include printing, facsimile transmission, or other suitable input of an electronic document for which handling by the controller function 300 is advantageous. The Parser 318 functions to interpret a received electronic document file and relay it to the job queue 312 for handling in connection with the afore-described functionality and components.

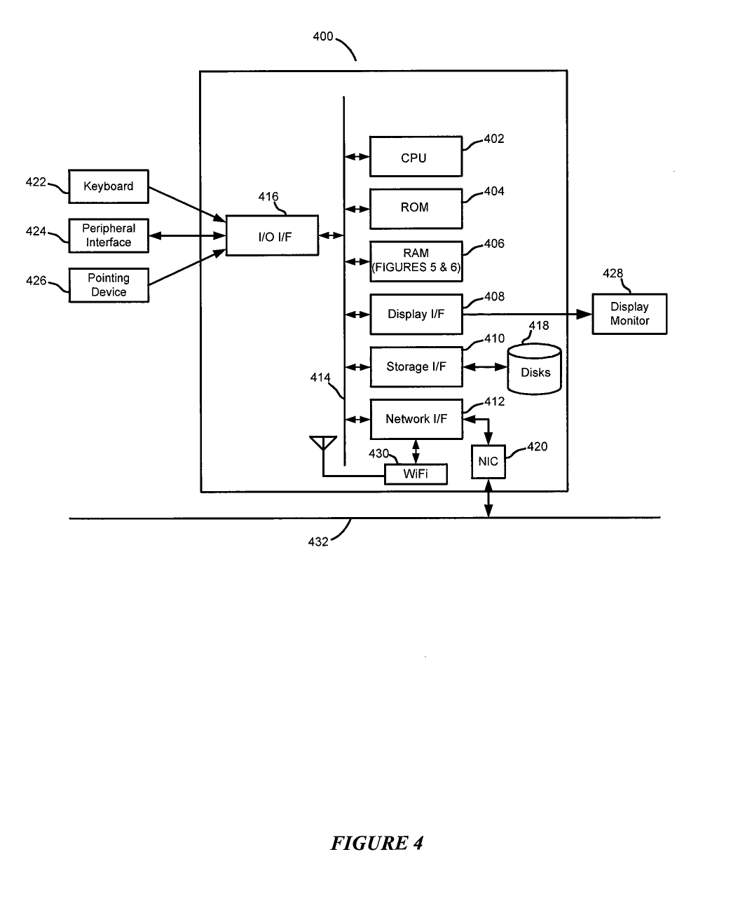

Turning now to FIG. 4, illustrated is a hardware diagram of a suitable workstation 400, shown in FIG. 1 as the user device 114, for use in connection with the subject system. A suitable workstation includes a processor unit 402 which is advantageously placed in data communication with read only memory 404, suitably non-volatile read only memory, volatile read only memory or a combination thereof, random access memory 406, display interface 408, storage interface 410, and network interface 412. In a preferred embodiment, interface to the foregoing modules is suitably accomplished via a bus 414.

The read only memory 404 suitably includes firmware, such as static data or fixed instructions, such as BIOS, system functions, configuration data, and other routines used for operation of the workstation 400 via CPU 402.

The random access memory 406 provides a storage area for data and instructions associated with applications and data handling accomplished by the processor 402.

The display interface 408 receives data or instructions from other components on the bus 414, which data is specific to generating a display to facilitate a user interface. The display interface 408 suitably provides output to a display terminal 428, suitably a video display device such as a monitor, LCD, plasma, or any other suitable visual output device as will be appreciated by one of ordinary skill in the art.

The storage interface 410 suitably provides a mechanism for non-volatile, bulk or long term storage of data or instructions in the workstation 400. The storage interface 410 suitably uses a storage mechanism, such as storage 418, suitably comprised of a disk, tape, CD, DVD, or other relatively higher capacity addressable or serial storage medium.

The network interface 412 suitably communicates to at least one other network interface, shown as network interface 420, such as a network interface card, and wireless network interface 430, such as a WiFi wireless network card. It will be appreciated that by one of ordinary skill in the art that a suitable network interface is comprised of both physical and protocol layers and is suitably any wired system, such as Ethernet, token ring, or any other wide area or local area network communication system, or wireless system, such as WiFi, WiMax, or any other suitable wireless network system, as will be appreciated by on of ordinary skill in the art. In the illustration, the network interface 420 is interconnected for data interchange via a physical network 432, suitably comprised of a local area network, wide area network, or a combination thereof.

An input/output interface 416 in data communication with the bus 414 is suitably connected with an input device 422, such as a keyboard or the like. The input/output interface 416 also suitably provides data output to a peripheral interface 424, such as a USB, universal serial bus output, SCSI, Firewire (IEEE 1394) output, or any other interface as may be appropriate for a selected application. Finally, the input/output interface 416 is suitably in data communication with a pointing device interface 426 for connection with devices, such as a mouse, light pen, touch screen, or the like.

In operation, electronic document data inclusive of page data representing a plurality of document pages is first received. A combine instruction is then received to combine the received page data. Multiple document pages are then combined into each of at least one output page in accordance with the received combine instruction. The combination includes first scaling multiple document pages associated with an output page and positioning each of the multiple document pages within a corresponding output page. The output pages are then communicated to an associated document rendering device so as to generate an output of output pages.

In accordance with one example embodiment of the subject application, electronic document data is received by an application, driver, or other software program, such as a filter, resident on the user device 114 for output to an associated document rendering device 104. Included in the electronic document data is page data representing multiple document pages of the electronic document. A combine instruction is then received from the associated user, e.g., an n-up output request, a duplex output request, a booklet form output request, or the like. The received electronic document is then filtered and multiple document pages associated with a corresponding output page are scaled via a filtering operation. Multiple document pages are also positioned within a corresponding output page via a filtering operation.

Multiple document pages are then combined via the scaling and positioning operations into at least one output page based upon the received combine instruction. In accordance with one embodiment of the subject application, the combining of multiple pages is accomplished via modifications made to a current transform matrix, which maps the original document positioning and scaling information to printed media position and scale. Thus, the skilled artisan will appreciate that the subject application enables the calculation of such a current transform matrix in accordance with the type of output, e.g., duplex output, n-up output, booklet output, and the like. The output pages are then communicated to an associated document rendering device 104 via the computer network 102. Thereafter, the document rendering device 104 outputs the output pages corresponding to the combined document pages of the received electronic document. In accordance with one particular embodiment of the subject application, the page data defining content of the document pages is at a higher resolution relative to corresponding content defined in output pages.

In accordance with one example embodiment employing the methodologies described above, when a user selects an n-up document processing operation, a filter enabled on the operating system of the user device 114 receives the electronic document data corresponding to the document to be output. Included with the document data is a combine instruction, which is interpretable by the filter to generate n-up output pages. The filter then generates n face slots and assigns an allocation order thereto. The filter then determines whether any additional pages of the electronic document remain for inclusion on the output document. When no more pages are located, the n-up output page is output to the document rendering device 104. When additional pages are detected, the filter then determines whether a free slot in the current page (face) is available. When no free slots remain, the current page is output to the document rendering device 104 and a new face (new output page) is generated.

When a slot is located on the output page, a current transform matrix is calculated and the page is assigned to a slot on the output page with the new current transform matrix. Operations then return to determining whether the page data includes any additional pages for output, whereupon the process repeats until all pages of the electronic document have been assigned to a face on an output page and the output pages have been communicated to the associated document rendering device 104.

According to a booklet document processing output example, upon receipt of an electronic document inclusive of page data representing multiple document pages and a combine instruction, a filter resident on the user device 114 interprets the combine instruction and generates two face slots and an allocation order to a first output page. A determination is then made whether any more input pages (document pages) remain. When a page remains, it is added to a pagelist. When no more pages remain, the next two pages in the pagelist are located and composed. Thereafter, a new face with two slots is generated. Dual current transform matrices are then calculated by the filter and pages are assigned to the slots in accordance with the two current transform matrices. The face, i.e., the output page, is then communicated to the associated document rendering device 104 for booklet output thereon. The operations then continue until all pages in the pagelist have been composed and output.

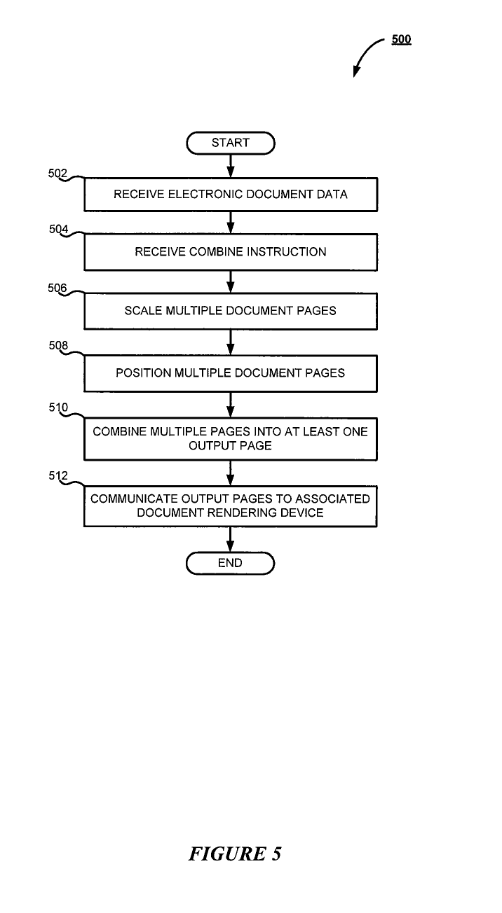

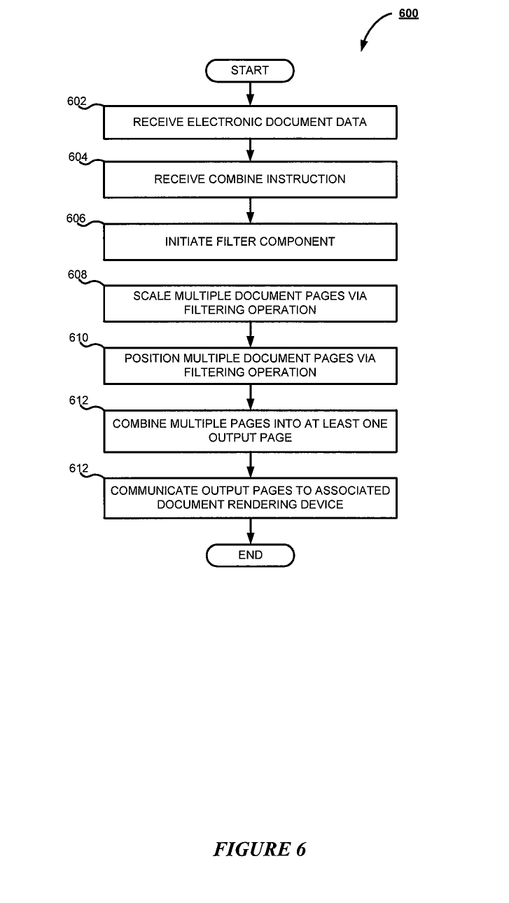

The skilled artisan will appreciate that the subject system 100 and components described above with respect to FIG. 1, FIG. 2, FIG. 3, and FIG. 4 will be better understood in conjunction with the methodologies described hereinafter with respect to FIG. 5 and FIG. 6. Turning now to FIG. 5, there is shown a flowchart 500 illustrating a method for pre-rendering of combined document pages in accordance with one embodiment of the subject application. Beginning at step 502, electronic document data, inclusive of page data representing multiple pages of the electronic document, is first received. It will be appreciated by those skilled in the art that a software driver, software application, or other suitable component resident on the user device 114 receives the electronic document data via another application resident thereon.

A combine instruction is then received at step 504 to combine multiple pages of the electronic document data into at least one output page. That is, an instruction has been received from a user associated with the user device 114 to combine one or more pages of the electronic document into a single output page. The skilled artisan will appreciate that such an operation includes, for example and without limitation, an n-up output, a booklet output, a duplex output, or the like. In accordance with the received combine instruction, and so as to effect the combination of multiple pages into at least one output page, the multiple pages associated with at least one output page are scaled at step 506. At step 508, each of the multiple document pages is then positioned within the corresponding output page. It will be appreciated by those skilled in the art that the scaling and positioning referenced above with respect to steps 506 and 508 are illustrated in FIG. 5 as scaling and then positioning for example purposes only, and any ordering of the steps is capable of being effected in accordance with the subject application.

The scaled and positioned document pages are then combined at step 510 into each of at least one output page based upon the received combine instruction. It will be understood by those skilled in the art that the combining of multiple document pages into multiple output pages is performed for each of the pages of the electronic document data, dependent upon the number of document pages, user preferences, and the like. At step 512, the output pages corresponding to the combined document pages, are then output to an associated document rendering device 104 via the computer network 102. Thereafter, the document rendering device 104 generates an output from the received output pages.

Referring now to FIG. 6, there is shown a flowchart 600 illustrating a method for pre-rendering of combined document pages in accordance with one embodiment of the subject application. The methodology of FIG. 6 begins at step 602, whereupon electronic document data, inclusive of multiple document pages, is received by a component associated with the user device 114. At step 604, the component of the user device 114 receives a combine instruction to combine one or more document pages into at least one output page, e.g., an n-up output request, a duplex output request, a booklet form output request, or the like. At step 606, a filter associated with the user device 114 is initiated to begin filtering operations on the received electronic document data. It will be appreciated by those skilled in the art that a filter, as used herein, corresponds to a software program capable of performing one or more functions on the user device 114, e.g., perform one or more document processing operations or the like.

At step 608, multiple document pages associated with a corresponding output page are scaled via a filtering operation. At step 610, multiple document pages are also positioned within a corresponding output page via a filtering operation. Multiple document pages are then combined via the scaling and positioning operations into at least one output page based upon the received combine instruction at step 612. As will be appreciated by those skilled in the art, the combination of multiple pages into an output page via modifications made to a current transform matrix, which maps the original document positioning and scaling information to printed media position and scale. In accordance with such an embodiment of the subject application, the current transform matrix is calculated in accordance with the type of output, e.g., duplex output, n-up output, booklet output, and the like. The output pages are then communicated, at step 614, to an associated document rendering device 104 via the computer network 102. Thereafter, the document rendering device 104 outputs the output pages corresponding to the combined document pages of the received electronic document.

The subject application extends to computer programs in the form of source code, object code, code intermediate sources and partially compiled object code, or in any other form suitable for use in the implementation of the subject application. Computer programs are suitably standalone applications, software components, scripts or plug-ins to other applications. Computer programs embedding the subject application are advantageously embodied on a carrier, being any entity or device capable of carrying the computer program: for example, a storage medium such as ROM or RAM, optical recording media such as CD-ROM or magnetic recording media such as floppy discs; or any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the subject application principles as described, will fall within the scope of the subject application.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A system for pre-rendering of combined document pages comprising:
means adapted for receiving electronic document data inclusive of page data representative of a plurality of document pages;
means adapted for receiving a combine instruction to combine page data;
combination means adapted for combining multiple document pages into each of at least one output page in accordance with a received combine instruction, the combination means including,
scaling means adapted for scaling multiple document pages associated with a corresponding output page, and
positioning means adapted for positioning each of the multiple document pages within a corresponding output page; and
means adapted for communicating output pages to an associated document rendering device so as to generate an output of output pages therefrom.

2. The system of claim 1 wherein the combination means includes a filter means adapted for filtering received electronic document data, and wherein the scaling means and the positioning means are completed via at least one filtering operation completed on the filter means.

3. The system of claim 2 wherein the combine instruction includes an instruction for combining page data into n-up output page data.

4. The system of claim 2 wherein the combine instruction includes an instruction for combining page data into booklet form page data.

5. The system of claim 2 wherein the combine instruction includes an instruction for combining page data into duplex form page data.

6. The system of claim 1 wherein the page data defines content of the document pages at a higher resolution relative to corresponding content defined in output pages.

7. A method for pre-rendering of combined document pages comprising the steps of:
receiving electronic document data inclusive of page data representative of a plurality of document pages;
receiving a combine instruction to combine page data;
combining multiple document pages into each of at least one output page in accordance with a received combine instruction, including the steps of,
scaling multiple document pages associated with a corresponding output page, and
positioning each of the multiple document pages within a corresponding output page; and
communicating output pages to an associated document rendering device so as to generate an output of output pages therefrom.

8. The method of claim 7 wherein the combining step includes filtering received electronic document data, and wherein the scaling step and the positioning step are completed via at least one filtering operation completed by the filtering step.

9. The method of claim 8 wherein the combine instruction includes an instruction for combining page data into n-up output page data.

10. The method of claim 8 wherein the combine instruction includes an instruction for combining page data into booklet form page data.

11. The method of claim 8 wherein the combine instruction includes an instruction for combining page data into duplex form page data.

12. The method of claim 7 wherein the page data defines content of the document pages at a higher resolution relative to corresponding content defined in output pages.

13. A computer-implemented method for pre-rendering of combined document pages comprising the steps of:
receiving electronic document data inclusive of page data representative of a plurality of document pages;
receiving a combine instruction to combine page data;
combining multiple document pages into each of at least one output page in accordance with a received combine instruction, including the steps of,
scaling multiple document pages associated with a corresponding output page, and
positioning each of the multiple document pages within a corresponding output page; and
communicating output pages to an associated document rendering device so as to generate an output of output pages therefrom.

14. The computer-implemented method of claim 13 wherein the combining step includes filtering received electronic document data, and wherein the scaling step and the positioning step are completed via at least one filtering operation completed by the filtering step.

15. The computer-implemented method of claim 14 wherein the combine instruction includes an instruction for combining page data into n-up output page data.

16. The computer-implemented method of claim 14 wherein the combine instruction includes an instruction for combining page data into booklet form page data.

17. The computer-implemented method of claim 14 computer-implemented wherein the combine instruction includes an instruction for combining page data into duplex form page data.

18. The computer-implemented method of claim 13 wherein the page data defines content of the document pages at a higher resolution relative to corresponding content defined in output pages.
